(19) United States
(12) Patent Application Publication
(10) Pub. No.: US 2015/0253611 A1
(43) Pub. Date: Sep. 10, 2015

(54) TWO-SIDED LIQUID CRYSTAL DISPLAY

(71) Applicant: LITEMAX ELECTRONICS INC., New Taipei City (TW)

(72) Inventors: TIEN-TENG YANG, NEW TAIPEI CITY (TW); CHUN-HUNG CHEN, NEW TAIPEI CITY (TW)

(73) Assignee: LITEMAX ELECTRONICS INC., New Taipei City (TW)

(21) Appl. No.: 14/199,068

(22) Filed: Mar. 6, 2014

(51) Int. Cl. G02F 1/1333

(52) U.S. Cl. CPC G02F 1/133308

(57) ABSTRACT

A two-sided liquid crystal display includes a base; a supporting pipe disposed at the base; a frame body connected to the supporting pipe; a first liquid crystal display panel unit disposed in the frame body; a second liquid crystal display panel unit disposed in the frame body and being parallel and adjacent to the first liquid crystal display panel unit; a first edge-lit backlight unit disposed in the frame body; a second edge-lit backlight unit disposed in the frame body; a control unit disposed in the base and electrically connected to the first liquid crystal display panel unit, second liquid crystal display panel unit, first edge-lit backlight unit and second edge-lit backlight unit; and a power unit disposed in the base and electrically connected to the control unit. Accordingly, the two-sided liquid crystal display has a simple structure, a low weight, and a small thickness.

### FIELD OF TECHNOLOGY

The present invention relates to liquid crystal displays, and more particularly, to a two-sided liquid crystal display of a simple structure, a low weight, and a small thickness.

### BACKGROUND

At present, in plenty of public spaces, such as playgrounds, airports, shopping malls, stations, and games shops, information and advertisement are displayed on acrylic billboards and light-emitting diode (LED) panels.

In the situation where information and advertisement are displayed on acrylic billboards, to update information and advertisement displayed on acrylic billboards, it is necessary to make a new acrylic billboard and thus incur an expenditure on users, not to mention that the users have to wait for the new acrylic billboard.

In the situation where information and advertisement are displayed on LED panels, the aforesaid pecuniary and timing-related concerns are dispensed with at the cost of others, namely high LED panel maintenance costs, as well as lackluster colors and patterns which are shown on the LED panels and thus fail to draw passersby's attention to the LED panels, let alone the information and advertisements displayed thereon.

Moreover, in some public spaces, two liquid crystal displays are arranged in a back-to-back manner to display information and advertisements in two opposite directions, and in consequence the total thickness of the back-to-back liquid crystal displays is twofold that of the thickness of each liquid crystal display. As a result, the back-to-back liquid crystal displays are bulky and heavy.

Accordingly, it is imperative to provide liquid crystal displays characterized by a simple structure, a low weight, and a small thickness, designed to display information and advertisements in two opposite directions, and adapted to allow users to change the displayed information and advertisements quickly and conveniently.

### SUMMARY

In view of the aforesaid drawbacks of the prior art, it is an objective of the present invention to provide a two-sided liquid crystal display characterized by a simple structure, a low weight, and a small thickness and adapted to allow users to change the displayed information and advertisements quickly and conveniently.

In order to achieve the above and other objectives, the present invention provides a two-sided liquid crystal display which comprises a base, a supporting pipe, a frame, a first liquid crystal display panel unit, a second liquid crystal display panel unit, at least a first edge-lit backlight unit, at least a second edge-lit backlight unit, a control unit, and a power unit.

The supporting pipe is disposed on the base. The frame is connected to the supporting pipe. The first liquid crystal display panel unit is disposed in the frame. The first liquid crystal display panel unit has a first display side, a. first rear side, and a plurality of first lateral edges. The second liquid crystal display panel unit is not only disposed in the frame and parallel to the first liquid crystal display panel unit, but also has a second display side, a. second rear side, and a plurality of second lateral edges. The first rear side is adjacent to the second rear side. The first edge-lit backlight unit is disposed in the frame. The first edge-lit backlight unit is disposed at the first lateral edges of the first liquid crystal display panel unit. The second edge-lit backlight unit is disposed in the frame. The second edge-lit backlight unit is disposed at the second lateral edges of the second liquid crystal display panel unit. The control unit is disposed in the base and electrically connected to the first liquid crystal display panel unit, the second liquid crystal display panel unit, the first edge-lit backlight unit and the second edge-lit backlight unit. The power unit is disposed in the base and electrically connected to the control unit.

As regards the two-sided liquid crystal display, the control unit has a first control unit and a second control unit. The first control unit is electrically connected to the first liquid crystal display panel unit and the first edge-lit backlight unit. The second control unit is electrically connected to the second liquid crystal display panel unit and the second edge-lit backlight unit.

As regards the two-sided liquid crystal display, the first rear side of the first liquid crystal display panel unit is positioned close to the second rear side of the second liquid crystal display panel unit.

The two-sided liquid crystal display further comprises a rotation unit disposed in the base. The rotation unit has a rotation platform, a rotary engine, and a circuit rotation connector. The rotation platform is connected to the supporting pipe, wherein the control unit is disposed on the rotation platform. The rotary engine drives the rotation platform to rotate. The circuit rotation connector is electrically connected to the control unit and the power unit.

In conclusion, the two-sided liquid crystal display of the present invention is characterized advantageously by a simple structure, a low weight, and a small thickness and adapted to allow users to change the displayed information and advertisements quickly and conveniently.

### BRIEF DESCRIPTION

Objectives, features, and advantages of the present invention are hereunder illustrated with specific embodiments in conjunction with the accompanying drawings, in which:

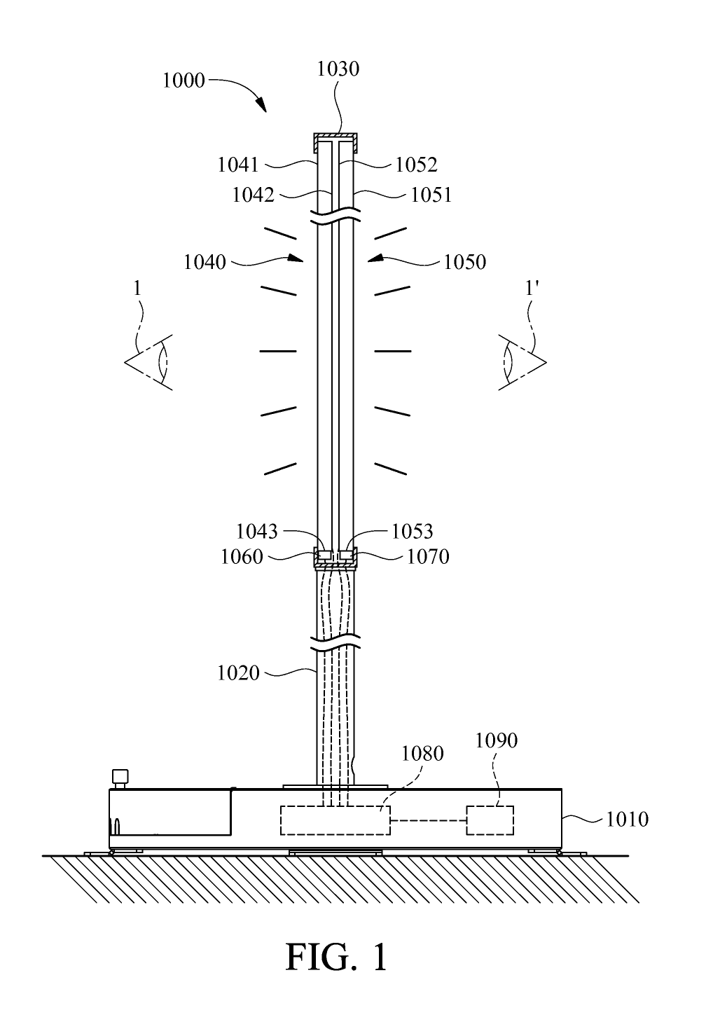

FIG. 1 is a cross-sectional view of a two-sided liquid crystal display according to the first embodiment of the present invention;

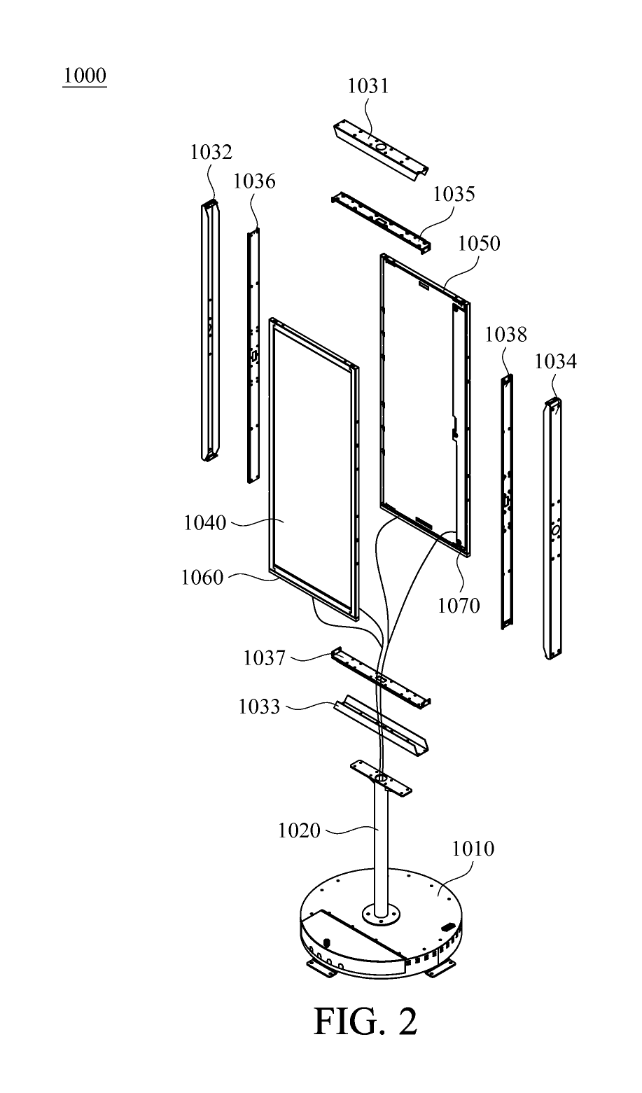

FIG. 2 is a partial exploded view of the two-sided liquid crystal display according to the first embodiment of the present invention;

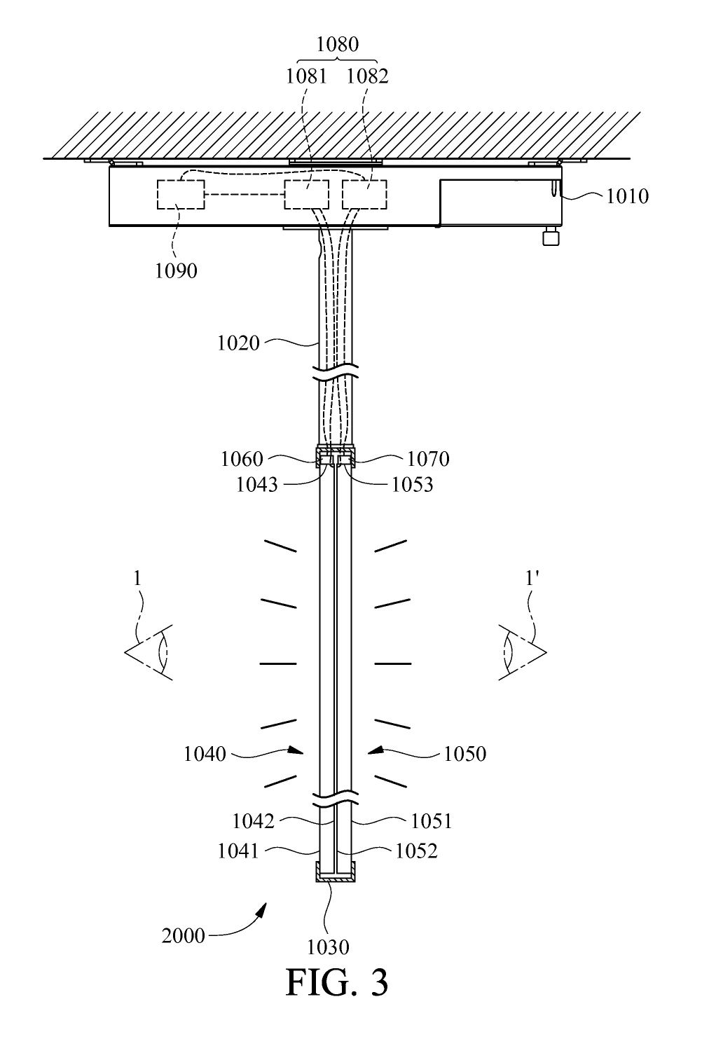

FIG. 3 is a cross-sectional view of a two-sided liquid crystal display according to the second embodiment of the present invention; and

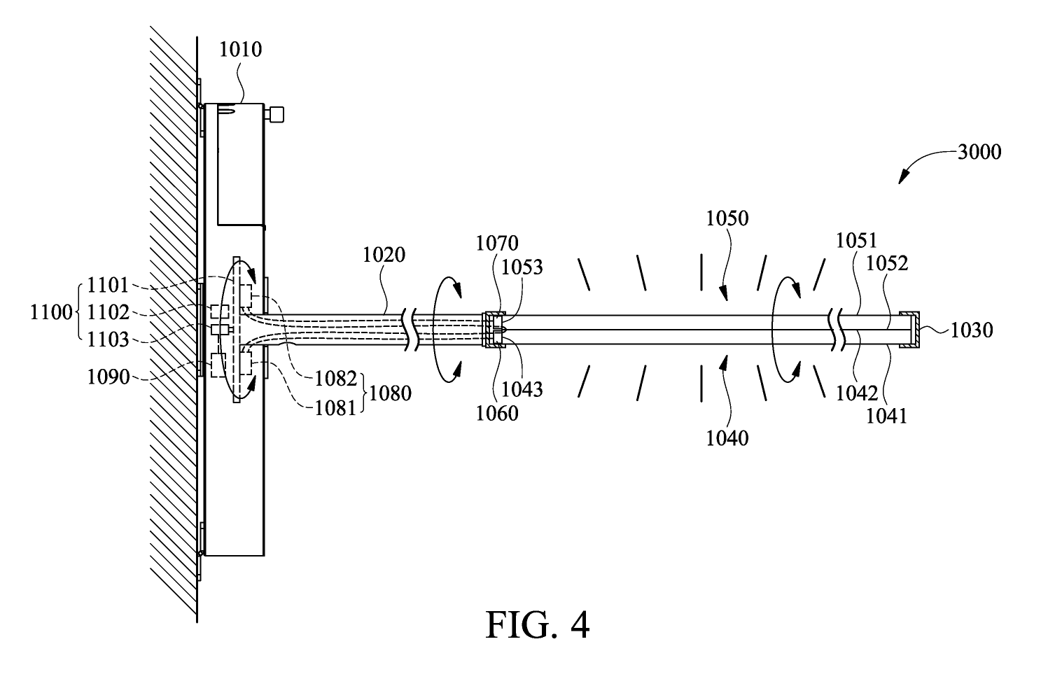

FIG. 4 is a cross-sectional view of a two-sided liquid crystal display according to the third embodiment of the present invention.

### DETAILED DESCRIPTION

Referring to FIG. 1, there is shown a cross-sectional view of a two-sided liquid crystal display 1000 according to the first embodiment of the present invention. The two-sided liquid crystal display 1000 comprises a base 1010, a supporting pipe 1020, a frame body 1030, a first liquid crystal display panel unit 1040, a second liquid crystal display panel unit 1050, at least a first edge-lit backlight unit 1060, at least a second edge-lit backlight unit 1070, a control unit 1080 and a power unit 1090.

The base 1010 is disposed on a ground or a desk. The supporting pipe 1020 is disposed on the base 1010. The frame body 1030 is connected to the supporting pipe 1020. Specifically speaking, the interior of the base 1010, the interior of the supporting pipe 1020, and a space defined by the frame body 1030 are in communication with each other. Moreover, referring to FIG. 2, the frame body 1030 comprises frames 1031-1038 whose quantity is subject to changes in accordance with the shape of the first liquid crystal display panel unit 1040 and the shape of the second liquid crystal display panel unit 1050.

Referring to FIG. 1, the first liquid crystal display panel unit 1040 is disposed in the frame body 1030, wherein the first liquid crystal display panel unit 1040 has a first display side 1041, a first rear side 1042 and a plurality of first lateral edges 1043.

The second liquid crystal display panel unit 1050 is disposed in the frame body 1030 and is parallel to the first liquid crystal display panel unit 1040. The second liquid crystal display panel unit 1050 has a second display side 1051, a second rear side 1052 and a plurality of second lateral edges 1053. The first rear side 1042 is adjacent to the second rear side 1052. Preferably, the first rear side 1042 is positioned closely to the second rear side 1052.

The first edge-lit backlight unit 1060 is disposed in the frame body 1030. The first edge-lit backlight unit 1060 is disposed at the first lateral edges 1043 of the first liquid crystal display panel unit 1040. The first edge-lit backlight unit 1060 is provided in the plural (not shown) and disposed at the first lateral edges 1043 of the first liquid crystal display panel unit 1040, respectively.

The second edge-lit backlight unit 1070 is disposed in the frame body 1030. The second edge-lit backlight unit 1070 is disposed at the second lateral edges 1053 of the second liquid crystal display panel unit 1050. The second edge-lit backlight unit 1070 is provided in the plural (not shown) and disposed at the second lateral edges 1053 of the second liquid crystal display panel unit 1050, respectively.

The control unit 1080 is disposed in the base 1010 and electrically connected to the first liquid crystal display panel unit 1040, the second liquid crystal display panel unit 1050, the first edge-lit backlight unit 1060, and the second edge-lit backlight unit 1070. The control unit 1080 controls the first liquid crystal display panel unit 1040 and the second liquid crystal display panel unit 1050 in displaying an information or an advertisement.

The power unit 1090 is disposed in the base 1010 and electrically connected to the control unit 1080, so as to supply power.

In conclusion, the two-sided liquid crystal display of the present invention is characterized in that: with the first liquid crystal display panel unit being adjacent to the second liquid crystal display panel unit, the joint use and operation of the first edge-lit backlight unit and the second edge-lit backlight unit, as well as the positioning of the control unit and the power unit on the base, is conducive to reduction of the thickness of the frame body. Moreover, the two-sided liquid crystal display of the present invention is characterized advantageously by a simple structure, a low weight, and a small thickness and adapted to allow users to change the displayed information and advertisements quickly and conveniently.

Referring to FIG. 3, there is shown a cross-sectional view of a two-sided liquid crystal display 2000 according to the second embodiment of the present invention. The constituent elements of the two-sided liquid crystal display 2000 are substantially the same as those of the two-sided liquid crystal display 1000. The control unit 1080 has a first control unit 1081 and a second control unit 1082. The first control unit 1081 is electrically connected to the first liquid crystal display panel unit 1040 and the first edge-lit backlight unit 1060. The second control unit 1082 is electrically connected to the second liquid crystal display panel unit 1050 and the second edge-lit backlight unit 1070. Specifically speaking, the first control unit 1081 controls the first liquid crystal display panel unit 1040 in displaying a first information or a first advertisement, whereas the second control unit 1082 controls the second liquid crystal display panel unit 1050 in displaying a second information or a second advertisement. Given its above design, the present invention is advantageously characterized in that the first liquid crystal display panel unit 1040 and the second liquid crystal display panel unit 1050 display different information and advertisements simultaneously.

Moreover, the base 1010 of the two-sided liquid crystal display 2000 is disposed at a ceiling. Referring to FIG. 4, there is shown a cross-sectional view of a two-sided liquid crystal display 3000 according to the third embodiment of the present invention. FIG. 4 is also a top view of the two-sided liquid crystal display 3000. The constituent elements of the two-sided liquid crystal display 3000 are substantially the same as those of the two-sided liquid crystal display 2000. The two-sided liquid crystal display 3000 further comprises a rotation unit 1100 which is disposed in the base 1010. The rotation unit 1100 has a rotation platform 1101, a rotary engine 1102, and a circuit rotation connector 1103. The base 1010 of the two-sided liquid crystal display 3000 is disposed on a wall surface. As the first rear side 1042 of the first liquid crystal display panel unit 1040 is positioned close to is positioned close to the second rear side 1052 of the second liquid crystal display panel unit 1050 so as to reduce the thickness of the two-sided liquid crystal display 3000 further.

The rotation platform 1101 is connected to the supporting pipe 1020. The control unit 1080 is disposed on the rotation platform 1101. The rotary engine 1102 drives the rotation platform 1101 to rotate. The supporting pipe 1020, the frame body 1030 and the control unit 1080 start to rotate as soon as the rotation platform 1101 starts to rotate. The circuit rotation connector 1103 is electrically connected to the control unit 1080 and the power unit 1090; hence, the wirings of the two-sided liquid crystal display 3000 are unlikely to get twisted with each other while the control unit 1080 is rotating. Given the above design of the present invention, users can remain stationary and watch the first information (or the first advertisement) displayed on the first liquid crystal display panel unit 1040 and the second information (or the second advertisement) displayed on the second liquid crystal display panel unit 1050.

Although the first liquid crystal display panel unit 1040 and the second liquid crystal display panel unit 1050 illustrated with FIG. 1 through FIG. 4 are rectangular, the present invention is not limited thereto. In practice, the first liquid crystal display panel unit 1040 and the second liquid crystal display panel unit 1050 can be of any shape well known among persons skilled in the art.

Moreover, although the above description does not mention that the two-sided liquid crystal displays 1000, 2000 each have the rotation unit 1100, persons skilled in the art understand that the rotation unit 1100 can be included in each of the two-sided liquid crystal displays 1000, 2000.

In conclusion, the two-sided liquid crystal display of the present invention is characterized advantageously by a simple structure, a. low weight, and a small thickness and adapted to allow users to change the displayed information and advertisements quickly and conveniently.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A two-sided liquid crystal display, comprising:
a base;
a supporting pipe disposed on the base;
a frame body connected to the supporting pipe;
a first liquid crystal display panel unit disposed in the frame body and having a first display side, a first rear side, and a plurality of first lateral edges;
a second liquid crystal display panel unit disposed in the frame body, parallel to the first liquid crystal display panel unit, and having a second display side, a second rear side, and a plurality of second lateral edges, the first rear side being adjacent to the second rear side;
at least a first edge-lit backlight unit disposed in the frame body and at the first lateral edges of the first liquid crystal display panel unit;
at least a second edge-lit backlight unit disposed in the frame body and at the second lateral edges of the second liquid crystal display panel unit;
a control unit disposed in the base and electrically connected to the first liquid crystal display panel unit, the second liquid crystal display panel unit, the first edge-lit backlight unit, and the second edge-lit backlight unit; and
a power unit disposed in the base and electrically connected to the control unit.

2. The two-sided liquid crystal display of claim 1, wherein the control unit has a first control unit and a second control unit, the first control unit being electrically connected to the first liquid crystal display panel unit and the first edge-lit backlight unit, and the second control unit being electrically connected to the second liquid crystal display panel unit and the second edge-lit backlight unit.

3. The two-sided liquid crystal display of claim 2, wherein the first rear side of the first liquid crystal display panel unit is positioned close to the second rear side of the second liquid crystal display panel unit.

4. The two-sided liquid crystal display of claim 1, wherein the first rear side of the first liquid crystal display panel unit is positioned close to the second rear side of the second liquid crystal display panel unit.

5. The two-sided liquid crystal display of claim 1, further comprising a rotation unit disposed in the base and having a rotation platform connected to the supporting pipe so as for the control unit to be disposed on the rotation platform, a rotary engine for driving the rotation platform to rotate, and a circuit rotation connector electrically connected to the control unit and the power unit.

6. The two-sided liquid crystal display of claim 2, further comprising a rotation unit disposed in the base and having a rotation platform connected to the supporting pipe so as for the control unit to be disposed on the rotation platform, a rotary engine for driving the rotation platform to rotate, and a circuit rotation connector electrically connected to the control unit and the power unit.

7. The two-sided liquid crystal display of claim 3, further comprising a rotation unit disposed in the base and having a rotation platform connected to the supporting pipe so as for the control unit to be disposed on the rotation platform, a rotary engine for driving the rotation platform to rotate, and a circuit rotation connector electrically connected to the control unit and the power unit.

8. The two-sided liquid crystal display of claim 4, further comprising a rotation unit disposed in the base and having a rotation platform connected to the supporting pipe so as for the control unit to be disposed on the rotation platform, a rotary engine for driving the rotation platform to rotate, and a circuit rotation connector electrically connected to the control unit and the power unit.
